(19) United States
(12) Patent Application Publication
(10) Pub. No.: US 2022/0309359 A1
(43) Pub. Date: Sep. 29, 2022

(54) ADVERSE FEATURES NEUTRALIZATION IN MACHINE LEARNING

(71) Applicant: PAYPAL, INC., San Jose, CA (US)

(72) Inventors: Yanzan Zhou, San Jose, CA (US); Zhetian Jin, Pittsburgh, PA (US)

(21) Appl. No.: 17/211,387

(22) Filed: Mar. 24, 2021

(51) Int. Cl. G06N 5/04; G06N 20/00

(52) U.S. Cl. CPC G06N 5/04; G06N 20/00

(57) ABSTRACT

Methods and systems are presented for identifying and neutralizing adverse input features that negatively impact accuracy of a machine learning model. A machine learning model is configured to produce an output based on parameter values corresponding to input features. Each input feature is evaluated with respect to its impact on producing a correct output by the machine learning model. One or more adverse input features that have a negative impact on accuracy of the machine learning model are determined. When a request to assess a data is received, input values associated with the data and corresponding to the set of input features are obtained. One or more input values corresponding to the adverse input features are identified. The one or more input values are altered, and the altered input values along with other unaltered input values are used to generate a more accurate output by the machine learning model.

### BACKGROUND

The present specification generally relates to improvements in computer machine learning technology, and more specifically, to neutralizing particular data features that contribute to incorrect predictions in a machine learning model according to various embodiments of the disclosure.

### RELATED ART

Machine learning models are often used to perform analysis and predictions (because they are capable of analyzing voluminous data and providing predictions quickly and accurately, based on patterns derived from historical data. A common application for using computer-based models is to perform data classification. Typically, a creator or an administrator of a machine learning model may first determine a set of input parameters (also referred to as “data features,” “input features,” or “features”) for the machine learning model. The set of input parameters may be associated with the data (e.g., attributes associated with a transaction, a user account, a patient, etc.). The machine learning model may be configured to receive such a set of input parameters and to provide an output value (e.g., a score) indicating a classification of the data based on calculations using the set of input parameters. By training the machine learning model using the training data, the way that the set of input parameters is manipulated to provide the output value may be adjusted to improve the consistency and accuracy performance of the machine learning model.

A benefit of machine learning is that one can configure a machine learning model to accept a set of input parameters (e.g., as determined by the creator to be relevant in the prediction), and simply let the machine learning model automatically learn to predict an output (e.g., a score, a classification, etc.) based on historical data without providing specific rules and algorithms (e.g., unsupervised learning). The machine learning model may automatically derive patterns (that the creator may or may not have recognized) for predicting the output. By training the machine learning model, the machine learning model may continue to learn new patterns and modify how the input parameters are manipulated to generate the output.

However, once a machine learning model is trained, the process of manipulating the input parameters may become a “black box” process that is not transparent to a user or the creator of the machine learning model. In particular, the user and/or the creator may not be aware of how each individual input parameter contributes to the prediction of the machine learning model. Applicant recognizes that when multiple different parameters are used for a machine learning model, the model may inadvertently make incorrect calculations on some of these parameters, adversely affecting performance of the overall model. Thus, Applicant recognizes there is a need for providing a mechanism to analyze the effect of individual input parameters on the prediction of the machine learning model to improve the performance of the machine learning model.

### BRIEF DESCRIPTION OF THE FIGURES

FIG. 1 is a block diagram illustrating a risk analysis module according to an embodiment of the present disclosure;

FIG. 2 is a block diagram illustrating an electronic transaction system according to an embodiment of the present disclosure;

FIG. 3A illustrates an example set of input features used by a machine learning model to produce an output according to an embodiment of the present disclosure;

FIG. 3B illustrates an example technique for neutralizing adverse input features according to an embodiment of the present disclosure;

FIG. 4 illustrates an example of calculating a Shapley value for the set of input features according to an embodiment of the present disclosure;

FIG. 5 illustrates an example neural network that can be used to implement a machine learning model according to an embodiment of the present disclosure;

FIG. 6 is a flowchart showing a process of identifying adverse input features associated with a machine learning model according to an embodiment of the present disclosure;

FIG. 7 is a flowchart showing a process of neutralizing the adverse input features according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for improving the performance of a machine learning model by identifying adverse input features that contribute to incorrect predictions of the machine learning model and neutralizing these adverse input features. As discussed above, a machine learning model learns and modifies itself within a “black box” environment and is not transparent to a user or the creator of the machine learning model according to various embodiments. The machine learning model may be configured to accept input values corresponding to a set of input features (e.g., the set of input parameters). However, once the machine learning model is trained, how the machine learning model manipulates the input values corresponding to the set of input features and how each input feature affects the final output of the machine learning model are unclear to a user or the creator of the machine learning model.

While the set of input features is assumed to be relevant to the prediction of the output, the assumption may be made based on guesses (e.g., educated guesses) by the creator of the machine learning model. After the training process, it may happen that some of the input features will contribute positively to performing a correct prediction (e.g., a correct classification or a correct categorization) of the data (the input feature(s) aids the machine learning model in reaching the correct prediction) while some other input features will contribute negatively to performing a correct prediction of the data (the input feature(s) hinders the machine learning model from reaching the correct prediction). Similarly, some of the input features will contribute positively to an incorrect prediction (e.g., an incorrect classification or an incorrect categorization) of data (the input feature(s) misleads the machine learning model to reach the incorrect prediction) while some other input features will contribute negatively to an incorrect prediction (the input feature(s) prevents the machine learning model from reaching the incorrect prediction). Additionally, even if all features have relevance to a machine learning model, just by the nature of the model construction and training process itself, internal rules of the model may result in some features contributing negatively to accuracy. For example, the model might be constructed such that 95 out of 100 features have internal corresponding rules or manipulations that are accurate (such as “if feature X is greater than 0.79, increase the model score by Y amount). However, inaccurate internal rules will frequently be present as well—e.g. the model may have an internal rule that effectively says “if a transaction amount is between $45.32 and $48.77, it has a higher risk of being fraud”, even if this is not the case in reality, because other associated internal rules are accurate, and the sum total of the model performs relatively well (but is not optimal, due to incorrect treatment of certain feature values).

Those input features that contribute negatively to performing a correct prediction (hinder the machine learning model from reaching the correct prediction) and/or contribute positively to performing an incorrect prediction (mislead the machine learning model to reach the incorrect prediction) are referred to as “adverse features” as these features have negative impact to the performance of the prediction. By identifying the adverse features and then neutralizing the effect of the adverse features, the prediction accuracy of a machine learning model can be improved.

Thus, according to various embodiments of the disclosure, a prediction system may analyze the input features of a machine learning model individually to identify one or more adverse features and neutralize the effect of the adverse features in subsequent predictions by the machine learning model. In some embodiments, the prediction system may analyze the impact that each individual input feature of a machine learning model has on the output of the machine learning model. The machine learning model may be configured to generate a score (e.g., a risk score, a disease likelihood score, etc.) based on input values corresponding to a set of input features.

In one example, the machine learning model may be configured to predict a risk associated with an electronic transaction (e.g., a login transaction, an electronic payment transaction, a content access transaction, etc.). In this example, the machine learning model may be configured to accept a set of input values corresponding to a set of input features related to electronic transactions, such as one or more of a payment amount associated with the transaction, a time of day or a day of month when the transaction was initiated, historic transaction frequency associated with an account involved in the transaction, historic transaction amounts associated with the account, an identity of a payee, a network address (e.g., an Internet Protocol (IP) address) of a device that initiated the electronic transaction, and other information associated with the electronic transaction. The machine learning model may be configured to generate a risk score representing a risk level associated with the electronic transaction based on the input values. The electronic transaction may then be classified as one of multiple classifications (e.g., a fraudulent transaction or a legitimate transaction) based on whether the output value exceeds a cutoff value.

In another example, the machine learning model may be configured to predict a health condition (e.g., a disease, an existence of antibody, etc.) of a patient. In this example, the machine learning model may be configured to accept a set of input values corresponding to a set of input features related to a patient, such as a blood pressure of the patient, a blood type of the patient, DNA characteristics of the patient, and other biometrics or test results associated with the patient. The machine learning model may be configured to generate a condition score representing a likelihood that the patient has the condition (e.g., has the disease, has the antibody, etc.) based on the input values. The patient may then be classified as one of multiple classifications (e.g., positive or negative) based on whether the output value exceeds a cutoff value.

When using a trained machine learning model to perform a prediction, each of the input values may be manipulated by the machine learning model, individually and/or in combination with one or other input values, in order for the machine learning model to determine the output value. Thus, each input value may contribute differently to the output value. For example, when the machine learning model is configured to predict a risk level associated with an electronic payment transaction, it is conceivable that a high transaction amount may contribute to an increase of the risk score, while a recognized IP address that is associated with the user account involved in the transaction may contribute to a decrease of the risk score. However, since the machine learning model may act like a black box, the overall impact of each input feature of the machine learning model is not readily available or ascertainable.

Thus, in some embodiments, the prediction system may analyze each input feature of the machine learning model to determine an impact that the input feature has to the output of the machine learning model. Different embodiments may use different techniques to evaluate the impact of each input feature.

In some embodiments, the prediction system may calculate a Shapley value for each of the input features of the machine learning model. A Shapley value of a particular input feature quantifies an overall impact that actual real-world input values corresponding to the particular input feature have to the output values of a machine learning model. To calculate a Shapley value for a particular input feature within the set of input features, the prediction system may use a set of input values associated with a real-world dataset (e.g., a real-world electronic transaction, an actual patient, etc.) and corresponding to the set of input features of the machine learning model. The prediction system may first use the machine learning model to produce an actual output value (e.g., a risk score, a condition likelihood score, etc.) based on the set of input values associated with the real-world dataset. The prediction system may then iteratively modify the input value corresponding to the particular input feature and use the machine learning model to produce an alternative output value for the real-world dataset based on the unaltered input values corresponding to the set of input features minus the particular input feature, in addition to the modified data value corresponding to the particular input feature.

In some embodiments, the prediction system may modify the input value based on possible values for the particular input feature. The possible values may be determined by a user or based on values of previous datasets obtained by the prediction system corresponding to the particular input feature. For example, when the particular input feature represents a numerical value such as a transaction amount of a payment transaction, the prediction system may determine a range of possible values based on transaction amounts associated with previously processed payment transactions (e.g., a minimum transaction amount, a maximum transaction amount, etc.). In another example, when the particular input feature represents a categorical value such as a product category or a color of an item, the prediction system may determine the possible values based on the different values corresponding to the particular input feature received by the prediction system. In some embodiments, the prediction system may randomly select a value within the range of values (or the possible values) during each iteration. During each iteration, the prediction system may determine a difference between the actual output value for the real-world dataset and the alternative output value.

Since the dataset has been previously processed by the prediction system or other systems, the dataset may be labeled with a pre-determined classification or categorization. For example, when the dataset represents an electronic transaction, the dataset may indicate that it is a fraudulent transaction or a legitimate transaction. When the dataset represents a condition of a patient, the dataset may indicate that the patient has or does not have the condition. As such, the prediction system may determine whether the machine learning model generates the correct prediction based on the set of input values including the value corresponding to the particular input feature (whether the actual output value indicates the correct classification or categorization). If the machine learning model generates a correct prediction, the prediction system may determine whether the particular input feature positively or negatively contributed to the correct prediction based on the differences between the actual output value and the alternative output values. For example, the prediction system may determine that the particular input feature contributes positively to the correct prediction when at least a portion (e.g., 60%, 80%, 90%, etc.) of the alternative output values are closer to a cutoff threshold than the actual output value, and may determine that the particular input feature contributes negatively to the correct prediction when at least a portion (e.g., 60%, 80%, 90%, etc.) of the alternative output values are farther away from a cutoff threshold than the actual output value.

When it is determined that the particular input feature positively contributed to the correct prediction (the particular input feature aids the machine learning model in reaching the correct prediction, i.e., positive Shapley value on true-positive population and negative Shapley value on true negative population), the prediction system may determine a positive feature impact based on the differences between the actual output value and the alternative output values (e.g., a mean difference, an average difference, etc.). When it is determined that the particular input feature negatively contributed to the correct prediction (the particular input feature hinders the machine learning model from reaching the correct prediction, i.e., positive Shapley value on true negative population and negative Shapley value on true positive population), the prediction system may determine a negative feature impact based on the differences between the actual output value and the alternative output values (e.g., a mean difference, an average difference, etc.).

If the machine learning model generates an incorrect prediction, the prediction system may determine whether the particular input feature positively or negatively contributed to the incorrect prediction based on the differences between the actual output value and the alternative output values. For example, the prediction system may determine that the particular input feature contributes positively to the incorrect prediction when at least a portion (e.g., 60%, 80%, 90%, etc.) of the alternative output values are closer to a cutoff threshold than the actual output value, and may determine that the particular input feature contributes negatively to the incorrect prediction when at least a portion (e.g., 60%, 80%, 90%, etc.) of the alternative output values are farther away from a cutoff threshold than the actual output value.

When it is determined that the particular input feature positively contributed to the incorrect prediction (the particular input feature misleads the machine learning model to reach the incorrect prediction, i.e., positive Shapley value on false positive population and negative Shapley value on false negative population), the prediction system may determine a negative feature impact based on the differences between the actual output value and the alternative output values (e.g., a mean difference, an average difference, etc.). When it is determined that the particular input feature negatively contributed to the incorrect prediction (the particular input feature helps in attempting to prevent the machine learning model from reaching the incorrect prediction, i.e., positive Shapley value on false negative population and negative Shapley value on false positive population), the prediction system may determine a positive feature impact based on the differences between the actual output value and the alternative output values (e.g., a mean difference, an average difference, etc.).

In some embodiments, instead of determining the feature impact for the particular input feature based on performing the iterative process on a single dataset (e.g., a single transaction, a single patient, etc.), the prediction system may perform the same iterative process on multiple datasets (e.g., multiple transactions, multiple patients, etc.) to derive the Shapley value for the particular input feature. For each transaction, the prediction system may use the machine learning model to determine an actual output value for the real-world dataset based on input values associated with the real-world dataset. The prediction system may then perform the iterative process—by iteratively modifying the input value corresponding to the particular input feature and determining alternative output values based on the modified input value. For each iteration, the prediction system may also determine a difference between the actual output value for the real-world dataset and the alternative output value generated during that iteration. The prediction system may then determine the Shapley value for the particular input feature based on the differences determined during the iteration process for the multiple datasets (e.g., a mean difference, an average difference, etc.).

In some embodiments, the prediction system may use a set of datasets (e.g., a set of transactions, a set of patients, etc.) for determining the Shapley value for the particular input feature. The set of datasets may correspond to a particular time period (e.g., transactions or patients received during the particular time period) and/or correspond to one or more attributes (e.g., transactions with amounts above a threshold amount such as $500, patients who has a particular blood type, etc.).

In some embodiments, the prediction system may use the same technique, as discussed herein, to quantify an impact (e.g., determining a Shapley value) that each of the input features has on the output of the machine learning model. Based on the Shapley values of the input features, the prediction system may identify one or more adverse input features that have adverse effect on the prediction performance of the machine learning model. For example, the prediction system may designate input features having negative feature impacts (e.g., having negative Shapley values on false negative population and positive Shapley values on false positive population) as adverse input features. In some example, the prediction system may designate input features having negative feature impacts below a threshold (e.g., −5, −10, etc.) as adverse input features.

Instead of using the Shapley value to quantify the impact that each of the input features has to the output of the machine learning model and identify adverse features, the prediction system of some embodiments may use different techniques such as partial dependence, individual condition expectation (ICE), and local interpretable model explanation (LIME). Partial dependence shows how the predictions partially depend on the values corresponding to the particular input feature. It could describe the particular input feature's average impact on the output of the machine learning model. However, partial dependence is not able to quantify the contribution of the particular input feature well when the particular input feature interacts strongly with other input features. ICE describes the impact on a particular prediction when the value corresponding to the particular input feature changes, which can be regarded as instance-level partial dependence. LIME estimates impact that the particular input feature has on the output of the machine learning model using a simple model to approximate a complex model (e.g. using linear regression to approximate a neural network). Thus, it may not work well for problems with non-linear relationship between input features and prediction target. These other techniques can be used in place of the Shapley value to identify adverse input features without departing from the spirit of this disclosure.

Once the adverse input features are identified, the prediction system may neutralize the effect of the adverse input features such that the accuracy performance of subsequent predictions by the machine learning model can be improved. Since the machine learning model has already been configured to accept input values corresponding to the set of input features (including the adverse input features) and have been trained based on the set of input features, it is not feasible according to various embodiments to remove the adverse input features from the set of input features. Furthermore, because the way that input values are being manipulated by the machine learning model is complex and intertwined, removing the adverse input features alone may not resolve the problem. More particularly, if a machine learning model was trained with 100 features and 12 were found to be negative (inaccurate), then it would be possible to drop those 12 features and retrain a second model using only the remaining 88 “good” features. However, such a second model would likely also (by virtue of the training process) end up with its own subset of negative (adverse) features. And generally, reducing the data set available to a machine learning model does not increase accuracy, but instead decreases it.

Thus, in some embodiments, the prediction system may neutralize the effect of the adverse input features by altering input values corresponding to the adverse input features before using the machine learning model to perform the prediction using the altered input values. For example, when the prediction system receives a request for performing a prediction based on a dataset (e.g., a new transaction, a new patient, etc.), the prediction system may obtain a set of data values associated with the dataset and corresponding to the set of input features. The prediction system may then alter the values in the set of data values that correspond to the identified adverse input features before providing the set of data values (including the altered values) to the machine learning model for performing the prediction.

In some embodiments, the prediction system may alter the values by changing the values by a predetermined amount (e.g., increase the transaction amount by $500, etc.). In some embodiments, the prediction system may alter the values by replacing the values using a replacement value. For example, after analyzing a particular input feature and determining that the particular input feature is an adverse input feature, the prediction system may determine a default replacement value for that particular input feature. The replacement value can be one that neutralizes the adverse effect of the particular input feature on the machine learning model. For example, the prediction system may determine the replacement value for the particular input feature based on a modified value used in one of the iterations, where the modified value leads to an alternative output value that is closer (e.g., closest) to a correct prediction. In some embodiments, the prediction system may use a mean value (or an average value) from a previously processed dataset as the replacement value for the particular input feature. In yet other embodiments, a dynamically generated replacement value could be used. In various instances, the goal of the replacement value is to prevent or mitigate the inaccurate effect that the model has for certain feature values within the data set that is presented to the model.

After altering the values corresponding to the adverse input features, the prediction system may feed the set of values (including the unaltered values that do not correspond to the adverse input features and the altered values that correspond to the adverse input features) to the machine learning model. Based on the set of values, the machine learning model may provide an output value that indicates a prediction (e.g., a classification, a categorization, etc.). It is noted that using the altered values, instead of the original value from the dataset, causes the machine learning model to provide more accurate predictions for the dataset.

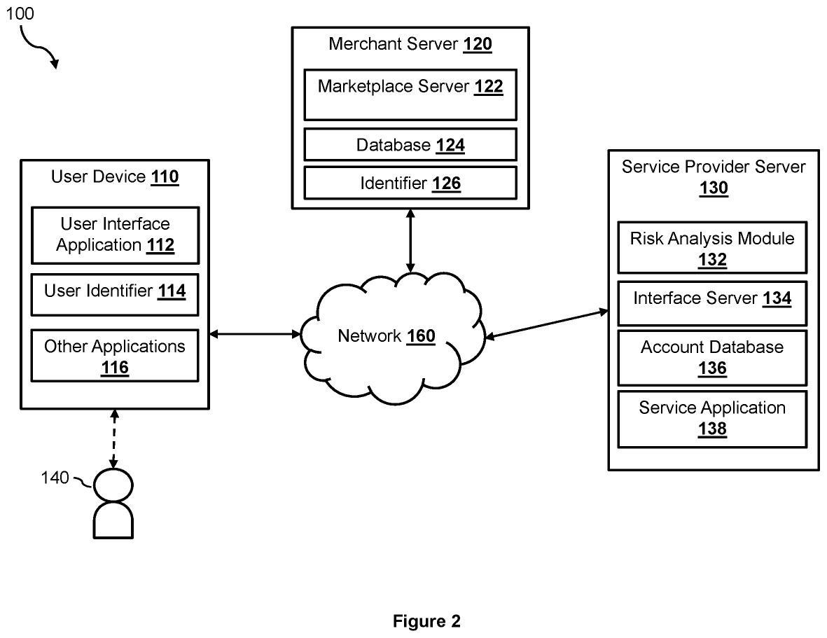

FIG. 2 illustrates an electronic transaction system 100, within which the prediction system may be implemented according to one embodiment of the disclosure. The electronic transaction system 100 includes a service provider server 130, a merchant server 120, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

In various implementations, the user 140 is able to input data and information into an input component (e.g., a keyboard) of the user device 110. For example, the user 140 may use the input component to interact with the UI application 112 (e.g., to add a new funding account, to provide information associated with the new funding account, to initiate an electronic payment transaction, etc.).

While only one user device 110 is shown in FIG. 2, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items, which may be made available to the user device 110 for viewing and purchase by the user.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items available for purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 2, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities. In some embodiments, the service provider server 130 may be associated with providing test result of patients (e.g., determining whether a condition exists within a patient, etc.).

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 includes a risk analysis module 132 that implements the prediction system as discussed herein. The risk analysis module 132 may be configured to use one or more machine learning models to predict a risk associated with a transaction request or a user account (e.g., whether a transaction request is associated with an unauthorized/fraudulent transaction, whether a user account has been used or taken over by malicious users, etc.). The prediction (e.g., classification of a transaction request or a user account as fraudulent or legitimate) can be used by the service application 138 to process the transaction request (e.g., to authorize or deny the transaction request) or to perform an action associated with a user account (e.g., to increase an authentication level of the user account, to suspend or lock a user account, etc.).

Thus, upon receiving a transaction request from the user device 110 and/or the merchant server 120, the service application 138 may use the risk analysis module 132 to determine whether the transaction request is associated with a fraudulent transaction or a legitimate transaction. The risk analysis module 132 may use one or more machine learning models to predict a risk score for the transaction request based on values (e.g., attributes) associated with the transaction request. As discussed herein, the attributes associated with the transaction request may correspond a set of input features for the one or more machine learning models, which may include a payment amount associated with the transaction, a time of day or a day of month when the transaction was initiated, historic transaction frequency associated with an account involved in the transaction, historic transaction amounts associated with the account, an identity of a payee, a network address (e.g., an Internet Protocol (IP) address) of a device that initiated the electronic transaction, and other information associated with the electronic transaction. The one or more machine learning models may provide a risk score based on the values of the transaction request. The risk analysis module 132 may classify the transaction request as a legitimate request or a fraudulent request based on whether the risk score exceeds a cutoff value.

The service application 138 may either process the transaction request if the risk analysis module 132 determines that it is associated with a legitimate transaction or deny the transaction request if the risk analysis module 132 determines that the request is associated with a fraudulent transaction. In other embodiments, the service application 138 may request additional information, such as additional authentication information, from the user 140 or user device 110 if the risk analysis module 132 determines that the request is associated with a possible fraudulent transaction.

In some embodiments, the risk analysis module 132 may identify adverse input features for the one or more machine learning models. Once the adverse input features are identified, the risk analysis module may neutralize the effect of the adverse input features on the output of the machine learning model. For example, upon receiving the transaction request and obtaining attributes of the transaction request, the risk analysis module 132 may alter one or more attributes corresponding to the adverse input features. The risk analysis module 132 then provide the altered attributes corresponding to the adverse input features and the unaltered attributes that do not correspond to the adverse input features to the one or more machine learning model for predicting a risk score.

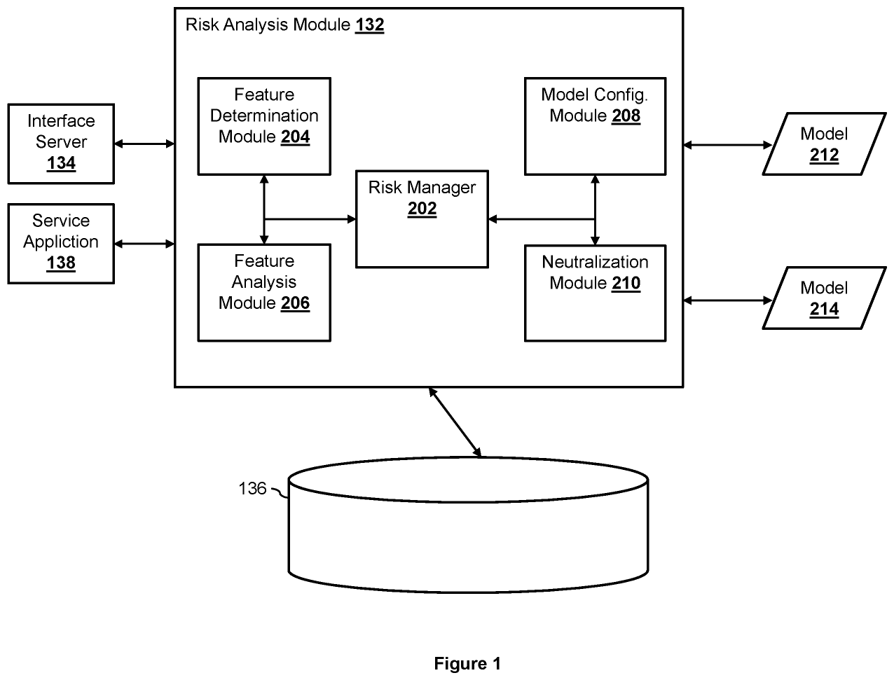

FIG. 1 illustrates a block diagram of the risk analysis module 132 according to an embodiment of the disclosure. The model development module 132 includes a risk manager 202, a feature determination module 204, a feature analysis module 206, a model configuration module 208, and a neutralization module 210. In some embodiments, the risk manager 202 may receive a request to assess a risk associated with a transaction or a transaction request. The request may be received from the interface server 134 or the service application 138 (e.g., when the user 140 uses the user device 110 to initiate an electronic transaction, such as a login transaction, an electronic payment transaction, a data access transaction, etc., with the service provider server 130). Upon receiving the transaction request, the risk manager 202 may use one or more of the machine learning models 212 and 214 to predict a risk associated with the transaction request.

Each of the machine learning models 212 and 214 may be implemented using any one or more of various machine learning architectures, such as a neural network, a gradient boosting tree, etc. The model configuration module 208 may configure each of the machine learning models 212 and 214 to accept input values corresponding to a set of input features that is associated with an electronic transaction, and to produce an output value based on the input values. Furthermore, the model configuration module 208 may also train each of the machine learning models 212 and 214 to produce an output value representing a risk of a transaction request based on input values associated with the transaction request. In some embodiments, the model configuration module 208 may use data associated with previously processed transactions that is stored in the database 136 to train the machine learning models 212 and 214. For example, the model configuration module 208 may determine attributes corresponding to the set of input features for each of the previously processed transactions based on the data stored in the database 136. The previously processed transactions may be labeled (e.g., the classifications determined by a human administrator, the machine learning models 212 and 214, or another classification model, or the classifications may be determined for the transactions after the transactions have been processed, etc.). Thus, the model configuration module 208 may train the machine learning models 212 and 214 based on the attributes and the labels associated with the previously processed transactions.

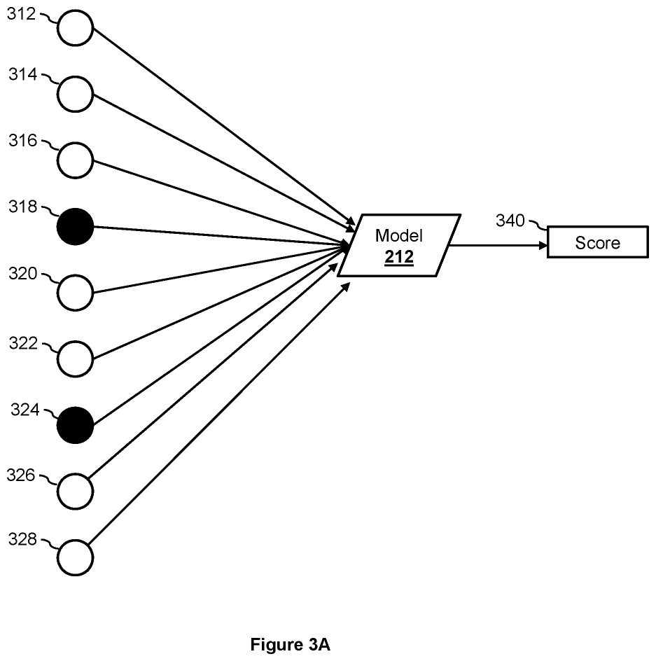

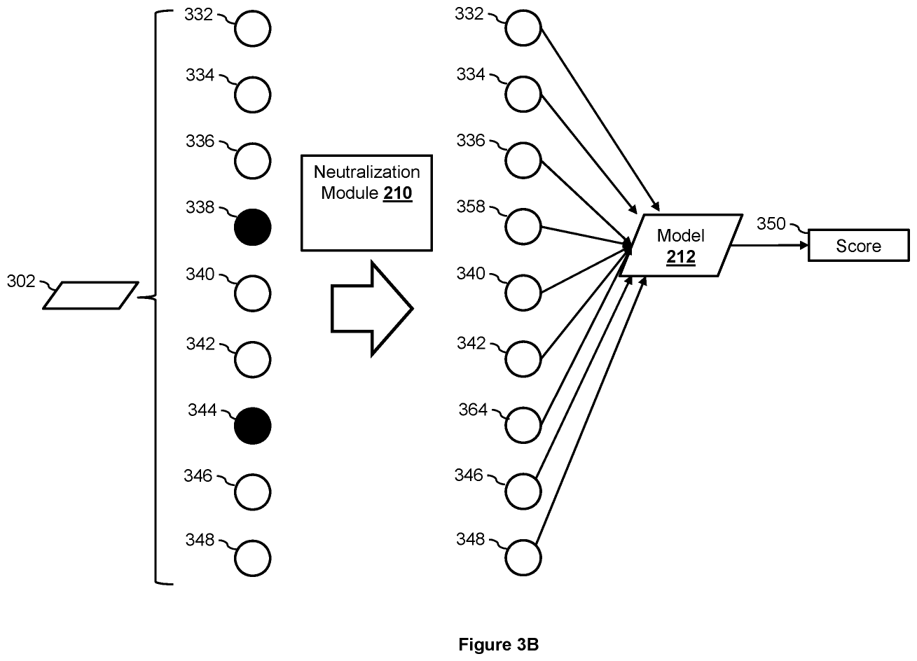

FIG. 3A illustrates a set of input features 312-328 that are used by the machine learning model 212 to perform a risk prediction according to various embodiments of the disclosure. The input features 312-328 may represent various attributes of a transaction or transaction request. For example, the input features 312-328 may include features such as a payment amount associated with the transaction, a time of day or a day of month when the transaction was initiated, historic transaction frequency associated with an account involved in the transaction, historic transaction amounts associated with the account, an identity of a payee, a network address (e.g., an Internet Protocol (IP) address) of a device that initiated the electronic transaction, and other information associated with the electronic transaction.

Upon receiving a transaction request (e.g., a transaction request 302), the risk manager 202 may obtain input values (e.g., attributes) associated with the transaction request and corresponding to the set of input features 312-328 and provide the input values to the machine learning model 212. Based on the input values, the machine learning model 212 may generate a risk score (e.g., a risk score 340) representing a risk associated with a transaction request. The risk score 340 may be used by the risk manager 202 to determine a classification for the transaction request (e.g., whether the transaction request is associated with a legitimate transaction or a fraudulent transaction, etc.) based on whether the risk score 340 exceeds a predetermined cutoff value. For example, if the risk score 340 exceeds the cutoff value (indicating that the risk associated with the transaction request is high), the risk manager 202 may classify the transaction request as a fraudulent transaction request. If the risk score 340 is below the cutoff value (indicating that the risk associated with the transaction request is low), the risk manager 202 may classify the transaction request as a legitimate transaction request.

In some embodiments, after training the machine learning model 212, the feature analysis module 206 may analyze the input features 312-328 of the machine learning models 212. Specifically, the feature analysis module 206 may determine an impact that each of the input features has on the outputs of the machine learning model 212. Based on the determined impact that each of the input features has on the output of the machine learning model 212, the feature determination model 204 may determine or identify, from the set of input features 312-328, one or more adverse input features. For example, the feature determination module 204 may determine input features that contribute negatively to a correct prediction of the machine learning model 212, and/or input features that contribute positively to an incorrect prediction of the machine learning model 212 as adverse input features. In this example, the feature determination module 204 may determine that the input features 318 and 324 are adverse input features based on the impacts the input features 318 and 324 have on the output of the machine learning model 212. As shown in FIG. 3A, the input features 318 and 324 that have been identified as adverse input features are shown in solid color while the other input features that are not identified as adverse input features (e.g., the input features 312, 314, 316, 320, 322, 326, and 328) are shown as hollow. In some embodiments, the neutralization module 210 may neutralize the effect of the adverse input features.

FIG. 3B illustrates neutralizing adverse input features according to various embodiments of the disclosure. In some embodiments, the neutralization module 210 may neutralize the effect of the adverse input features 318 and 324 by altering input values corresponding to the adverse input features 318 and 324 before providing the altered input values to the machine learning model 212. For example, upon receiving a transaction request 302, the risk manager 202 may obtain input values (attributes) 332-348 associated with the transaction request 302 and corresponding to the set of input features 312-328. In some embodiments, instead of providing the input values 332-348 directly to the machine learning model 212, the neutralization module 210 may alter the input values 338 and 344 corresponding to the adverse input features (e.g., the adverse input features 318 and 324) before providing the input values (including the altered input values) to the machine learning model 212. In this example, the neutralization module 210 may alter the input values 338 and 344 (e.g., changing the input values 338 and 344 into input values 358 and 364, respectively). The neutralization module 210 may then provide the input values, including unaltered input values 332, 334, 336, 340, 342, 346, and 348 and altered input values 358 and 364 to the machine learning model 212. The machine learning model 212 may generate a risk score 350 based on the input values 332, 334, 336, 358, 340, 342, 364, 346, and 348. It is noted that the risk score 350 generated by the machine learning model 212 would be different than a risk score generated by the machine learning model based on the original set of input values 332-348 (without the altering).

In some embodiments, the feature analysis module 206 may analyze the input features 312-328 in order to identify the input features 318 and 324 as adverse input features. Specifically, the feature analysis module 206 may evaluate an impact that each input feature has on the output (e.g., the score 340) of the machine learning model 212. The feature analysis module 206 may calculate, for each input feature, a feature impact (also referred to as a “feature impact score”) that represents an impact the input feature has on the output of the machine learning model 212 based on a Shapley value of the feature. A feature impact of a particular input feature quantifies an overall impact that actual real-world input values corresponding to the particular input feature has to the output values of a machine learning model. To calculate a feature impact score for a particular input feature within the set of input features, the feature analysis module 206 may use one or more real-world transactions (e.g., transactions that were previously received and processed by the service provider server 130, etc.). For example, the feature analysis module 206 may select a first transaction, and obtain input values (e.g., attributes) that are associated with the first transaction and correspond to the set of input features 312-328. The feature analysis module 206 may first use the machine learning model 212 to produce an actual output value (e.g., a risk score, etc.) based on the set of input values associated with the first transaction. The feature analysis module 206 may then iteratively modify the input value corresponding to the particular input feature (e.g., the input feature 312), and use the machine learning model 212 to produce an alternative output value for the first transaction based on the unaltered input values corresponding to the set of input features minus the particular input feature (e.g., the input features 314-328), in addition to the modified data value corresponding to the particular input feature (e.g., the input feature 312).

In some embodiments, the feature analysis module 206 may modify the input value based on possible values for the particular input feature (e.g., the input feature 312). The possible values may be determined by a user or based on values of previous transactions processed by the service provider server 130. For example, when the input feature 312 represents a numerical value such as a transaction amount of a payment transaction, the feature analysis module 206 may determine a range of possible values based on transaction amounts associated with previously processed payment transactions (e.g., a minimum transaction amount, a maximum transaction amount, etc.). In another example, when the input feature 312 represents a categorical value such as a product category or a color of an item, the feature analysis module 206 may determine the possible values based on the different values corresponding to the input feature 312 in previous transactions received and/or processed by the service provider server 130. In some embodiments, the feature analysis module 206 may randomly select a value within the range of values (or the possible values) during each iteration, such that a different input value corresponding to the input feature 312 may be chosen. During each iteration, the feature analysis module 206 may use the machine learning model 212 to generate an alternative output value based on the unaltered input values corresponding to the other input features (e.g., the input features 314-328) and the altered input value corresponding to the particular input feature (e.g., the input feature 312). The feature analysis module 206 system may then determine a difference between the actual output value for the first transaction and the alternative output value generated based on the altered input value corresponding to the input feature 312. After iterating through the altering the input value corresponding to the input feature 312 and the generating the alternative output value, the feature analysis module 206 may determine multiple differences (each a difference between the actual output value and the corresponding alternative output value) for the different iterations.

Since the first transaction has been previously processed by the service provider server 130 or other systems, the first transaction may be labeled with a pre-determined classification. For example, the first transaction may indicate that it is associated with a fraudulent transaction or a legitimate transaction. As such, the feature analysis module 206 may determine whether the machine learning model 212 generates the correct prediction for the first transaction based on the actual output value. If the machine learning model 212 generates a correct prediction, the feature analysis module 206 may determine whether the particular input feature (e.g., the input feature 312) positively or negatively contributed to the correct prediction based on the differences between the actual output value and the alternative output values. For example, the feature analysis module 206 may determine that the input feature 321 contributes positively to the correct prediction when at least a portion (e.g., 60%, 80%, 90%, etc.) of the alternative output values are closer to a cutoff threshold than the actual output value (the actual output value indicates a stronger correct prediction than the alternative output values), and may determine that the input feature 312 contributes negatively to the correct prediction when at least a portion (e.g., 60%, 80%, 90%, etc.) of the alternative output values are farther away from a cutoff threshold than the actual output value (the actual output value indicates a weaker correct prediction than the alternative output values).

When it is determined that the particular input feature positively contributed to the correct prediction (the particular input feature aids the machine learning model in reaching the correct prediction), the feature analysis module 206 may determine a positive feature impact score based on the differences between the actual output value and the alternative output values (e.g., a mean difference, an average difference, etc.). When it is determined that the particular input feature negatively contributed to the correct prediction (the particular input feature hinders the machine learning model from reaching the correct prediction), the feature analysis module 206 may determine a negative feature impact score based on the differences between the actual output value and the alternative output values (e.g., a mean difference, an average difference, etc.).

If the machine learning model generates an incorrect prediction, the feature analysis module 206 may determine whether the particular input feature (e.g., the input feature 312) positively or negatively contributed to the incorrect prediction based on the differences between the actual output value and the alternative output values. For example, the feature analysis module 206 may determine that the particular input feature (e.g., the input feature 312) contributes positively to the incorrect prediction when at least a portion (e.g., 60%, 80%, 90%, etc.) of the alternative output values are closer to a cutoff threshold than the actual output value (the actual output value indicates a stronger wrong prediction than the alternative output values), and may determine that the particular input feature (e.g., the input feature 312) contributes negatively to the incorrect prediction when at least a portion (e.g., 60%, 80%, 90%, etc.) of the alternative output values are farther away from a cutoff threshold than the actual output value (the actual output value indicates a weaker wrong prediction than the alternative output values).

When it is determined that the particular input feature positively contributed to the incorrect prediction (the particular input feature misleads the machine learning model to reach the incorrect prediction), the feature analysis module 206 may determine a negative feature impact score based on the differences between the actual output value and the alternative output values (e.g., a mean difference, an average difference, etc.). When it is determined that the particular input feature negatively contributed to the incorrect prediction (the particular input feature helps in attempting to prevent the machine learning model from reaching the incorrect prediction), the feature analysis module 206 may determine a positive feature impact score based on the differences between the actual output value and the alternative output values (e.g., a mean difference, an average difference, etc.).

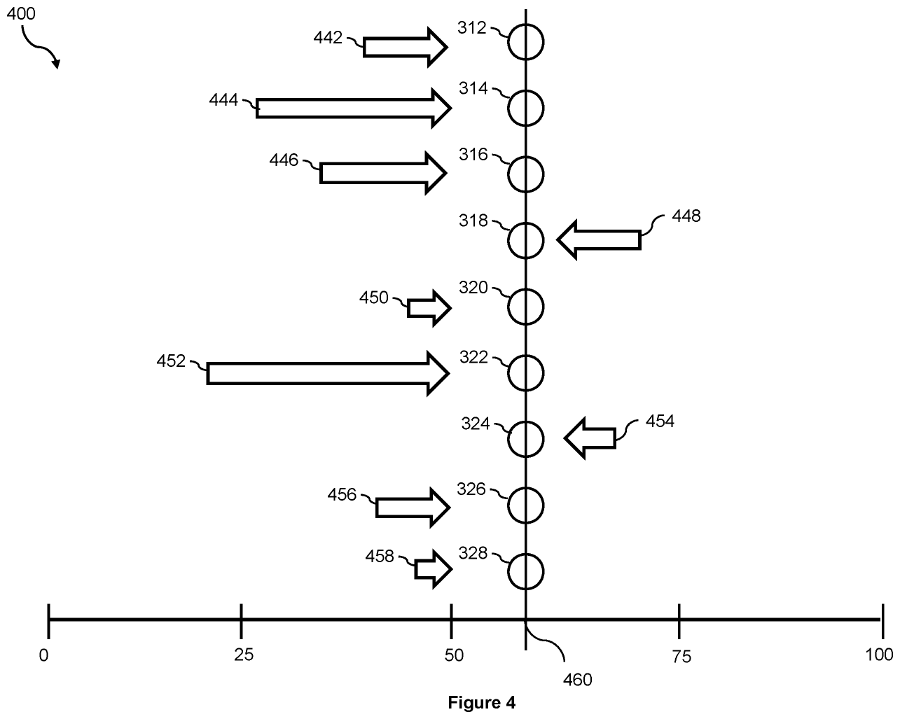

The feature analysis module 206 may use the same techniques disclosed herein to calculate a feature impact score for every input feature in the set of input features 312-328. FIG. 4 illustrates a graph 400 representing the feature impact scores calculated for the different input features 312-328 based on a single transaction (e.g., the transaction 302). Using the input values (attributes) associated with the transaction 302, the feature analysis module 206 may determine, using the machine learning model 212, an actual output value 460 (e.g., a risk score of 58). Assuming that the cutoff value for classifying transactions is 50, the actual output value 460 indicates that the transaction 302 is a fraudulent transaction. The feature analysis module 206 may also determine that the classification of the transaction 302 is correct based on the label associated with the transaction 302. By using the techniques disclosed herein, the feature analysis module 206 may determine that the input features 312, 314, 316, 320, 322, 326, and 328 contribute positively to the correct prediction, as indicated by the direction of the arrows 442, 444, 446, 450, 452, 456, and 458 pointing toward the higher risk score. Thus, the feature analysis module 206 may calculate positive feature impact scores for the input features 312, 314, 316, 320, 322, 326, and 328. In this graph 400, the size of the arrows 442, 444, 446, 450, 452, 456, and 458 indicates the corresponding feature impact scores (e.g., the longer the arrow, the higher the feature impact scores). The feature analysis module 206 may also determine that the input features 318 and 324 contribute negatively to the correct prediction, as indicated by the direction of the arrows 448 and 454 pointing toward the lower risk score. Thus, the feature analysis module 206 may calculate negative feature impact scores for the input features 318 and 324. In this graph 400, the size of the arrows 448 and 454 indicates the corresponding feature impact scores (e.g., the longer the arrow, the smaller the feature impact scores).

In some embodiments, instead of calculating the feature impact scores based on manipulating input values associated with a single transaction, the feature analysis module 206 may perform the same iterative process on multiple transactions to derive the feature impact score for the particular input feature. For each transaction, the feature analysis module 206 may use the machine learning model 212 to determine an actual output value for the transaction based on input values associated with the transaction. For example, the feature analysis module 206 may perform the iterative process—by iteratively modifying the input value corresponding to the particular input feature and determining alternative output values based on the modified input value using input values (attributes) associated with a second transaction. For each iteration, the feature analysis module 206 may also determine a difference between the actual output value for the second transaction and the alternative output value generated during that iteration. The feature analysis module 206 may continue to perform the iteration process on the particular input feature based on attributes associated with a third transaction and so forth. The feature analysis module 206 may then determine the feature impact score for the particular input feature based on the differences determined during the iteration process for the multiple transactions (e.g., a mean difference, an average difference, etc.).

In some embodiments, the feature determination module 204 may identify, from the set of input features 312-328, one or more input features as adverse input features. For example, the feature determination module 204 may determine that any input features with a negative feature impact scores (e.g., having negative Shapley values on false negative population and positive Shapley values on false positive population) are adverse input features. In this example, based on the calculated feature impact scores, the feature determination module 204 may determine that the input features 318 and 324 are adverse features since only the input features 318 and 324 have negative feature impact scores. In some embodiments, the feature determination module 204 may determine that input features having a feature impact score below a threshold other than 0 (e.g., 2.5, 0.5, −1, −5, etc.) are adverse input features.

After determining the adverse input features, the neutralization module 210 may neutralize the effect of the adverse input features in subsequent classification of transactions. In some embodiments, the neutralization module 210 may neutralize the effect of the adverse input features 318 and 324 by altering input values corresponding to the adverse input features 318 and 324 before using the machine learning model 212 to perform a prediction using the altered input values. For example, when the risk analysis module 132 receives a request for performing a classification based on a new transaction, the risk manager 202 may obtain a set of data values associated with the new transaction and corresponding to the set of input features 312-328. The neutralization module 210 may then alter the values in the set of data values that correspond to the adverse input features 318 and 324. The risk manager 202 may then provide the unaltered data values corresponding to the input features not identified as adverse (e.g., the input features 312, 314, 316, 320, 322, 326, and 328) and the altered values corresponding to the adverse input features 318 and 324 to the machine learning model 212 for performing the classification.

In some embodiments, the neutralization module 210 may alter the values by changing the values by a predetermined amount (e.g., increase the transaction amount by $500, etc.). In some embodiments, the neutralization module 210 may alter the values by replacing the values using a predetermined replacement value. For example, the neutralization module 210 may determine a default replacement value for each of the adverse input features. The replacement value can be one that neutralizes the adverse effect of the adverse input feature on the machine learning model 212. For example, the neutralization module 210 may determine the replacement value for a particular adverse input feature based on a modified value used in one of the iterations (during the input feature analysis process), where the modified value leads to an alternative output value that is closer (e.g., closest) to a correct prediction. In some embodiments, the neutralization module 210 may use a mean value (or an average value) from previously processed transactions as the replacement value for the particular adverse input feature.

After altering the values corresponding to the adverse input feature(s), the risk manager 202 may feed the set of values (including the unaltered values that do not correspond to the adverse input features and the altered values that correspond to the adverse input features) to the machine learning model 212. Based on the set of values, the machine learning model 212 may provide a risk score for the new transaction.

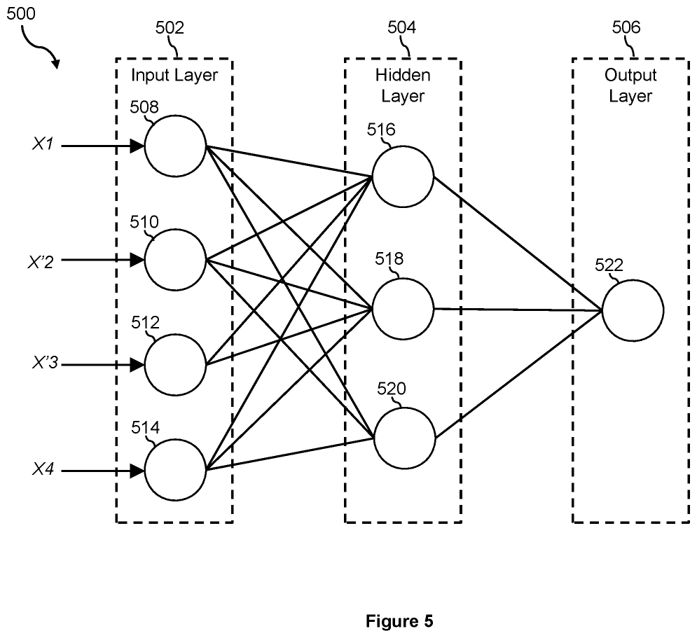

In some embodiments, the risk analysis module 132 may perform the same process to identify adverse input features and neutralize the adverse input features for other machine learning models such as the machine learning model 214. FIG. 5 illustrates an example artificial neural network 500 that may be used to implement the any one of the machine learning models 212 and 214. As shown, the artificial neural network 500 includes three layers—an input layer 502, a hidden layer 504, and an output layer 506. Each of the layers 502, 504, and 506 may include one or more nodes. For example, the input layer 502 includes nodes 508-514, the hidden layer 504 includes nodes 516-520, and the output layer 506 includes a node 522. In this example, each node in a layer is connected to every node in an adjacent layer. For example, the node 508 in the input layer 502 is connected to all of the nodes 516-520 in the hidden layer 504. Similarly, the node 516 in the hidden layer is connected to all of the nodes 508-514 in the input layer 502 and the node 522 in the output layer 506. Although only one hidden layer is shown for the artificial neural network 500, it has been contemplated that the artificial neural network 500 used to implement any one of the machine learning models 212 and 214 may include as many hidden layers as necessary.

In this example, the artificial neural network 500 receives a set of input values and produces an output value. Each node in the input layer 502 may correspond to a distinct input value. For example, when the artificial neural network 500 is used to implement the machine learning model 212, each node in the input layer 502 may correspond to a distinct input feature in the set of input features 312-328.

In some embodiments, each of the nodes 516-520 in the hidden layer 504 generates a representation, which may include a mathematical computation (or algorithm) that produces a value based on the input values received from the nodes 508-514. The mathematical computation may include assigning different weights (e.g., node weights, etc.) to each of the data values received from the nodes 508-514. The nodes 516-520 may include different algorithms and/or different weights assigned to the data variables from the nodes 508-514 such that each of the nodes 516-520 may produce a different value based on the same input values received from the nodes 508-514. In some embodiments, the weights that are initially assigned to the features (or input values) for each of the nodes 516-520 may be randomly generated (e.g., using a computer randomizer). The values generated by the nodes 516-520 may be used by the node 522 in the output layer 506 to produce an output value for the artificial neural network 500. When the artificial neural network 500 is used to implement the machine learning model 212, the output value produced by the artificial neural network 500 may include a risk score that indicates a classification of data (e.g., a classification of a transaction) dependent on a cutoff value.

The artificial neural network 500 may be trained by using training data. By providing training data to the artificial neural network 500, the nodes 516-520 in the hidden layer 504 may be trained (adjusted) such that an optimal output (e.g., a risk score, a classification, etc.) is produced in the output layer 506 based on the training data. By continuously providing different sets of training data, and penalizing the artificial neural network 500 when the output of the artificial neural network 500 is incorrect (e.g., when the determined (predicted) likelihood is inconsistent with whether the profile is connected with the entity, etc.), the artificial neural network 500 (and specifically, the representations of the nodes in the hidden layer 504) may be trained (adjusted) to improve its performance in data classification. Adjusting the artificial neural network 500 may include adjusting the weights associated with each node in the hidden layer 504.

Instead of, or in addition to, an artificial neural network, the risk analysis module 132 may use other implementations of machine learning model for predicting a risk associated with various transactions. For example, while the machine learning model 212 may be implemented using an artificial neural network such as one the artificial neural network 500 illustrated in FIG. 5, the machine learning model 214 may be implemented using a different machine learning technique such as a gradient boosting tree.

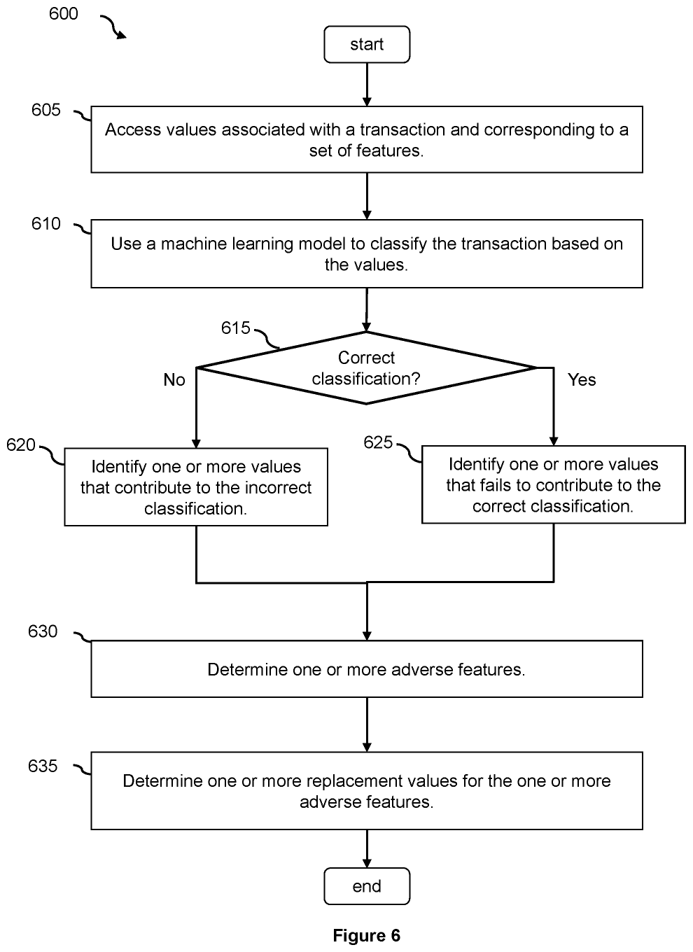

FIG. 6 illustrates a process 600 for identifying adverse input features for a trained machine learning model according to various embodiments of the disclosure. In some embodiments, at least a portion of the process 600 may be performed by the risk analysis module 132. The process 600 begins by accessing (at step 605) values associated with a transaction and corresponding to a set of input features. For example, the feature analysis module 206 may access a first transaction that has been previously processed by the service provider server 130. The feature analysis module 206 may then obtain input values (e.g., attributes) associated with the first transaction and corresponding to the set of input features (e.g., the input features 312-328) associated with the machine learning model 212.

The process 600 then uses (at step 610) a machine learning model to classify the transaction based on the values. For example, the feature analysis module 206 may use the machine learning model 212 to determine a risk score based on the input values associated with the first transaction. Based on the risk score, the feature analysis module 206 may determine whether the first transaction is a legitimate transaction or a fraudulent transaction.

The process 600 determines (at step 615) whether the classification is correct. If it is determined that the classification is correct, the process 600 identifies (at step 625) one or more values that fails to contribute to the correct classification. On the other hand, if it is determined that the classification is incorrect, the process 600 identifies (at step 620) one or more values that contribute to the incorrect classification. For example, the feature analysis module 206 may determine whether the classification from the machine learning model 212 is correct by comparing the classification to a label associated with the first transaction. The feature analysis module 206 may then evaluate an impact that each input feature has on the output of the machine learning model 212. In some embodiments, the feature analysis module 206 may calculate a feature impact score for each of the input features based on a Shapley value. To calculate the feature impact score, the feature analysis module 206 may first use the machine learning model 212 to determine an actual risk score for the first transaction based on the input values associated with the first transaction. The feature analysis module 206 may then iteratively altering an input value corresponding to a particular input feature and use the machine learning model 212 to determine an alternative risk score based on the altered input value. The feature analysis module 206 may then calculate the feature impact score for the particular input feature based on the differences between the actual risk score and the alternative risk scores. In some embodiments, a negative feature impact score may indicate a positive contribution to an incorrect prediction or a negative contribution to a correct prediction.

The process 600 then determines (at step 630) one or more adverse features. For example, the feature determination module 204 may determines that one or more input features are adverse input features based on the feature impact scores determined for the set of input features 312-328. In some embodiments, the feature determination module 204 may determine a threshold value (e.g., 0, −0.5, −5, etc.), and may determine that any input feature having a feature impact score below the threshold Shapley value is an adverse input feature. The process 600 determines (at step 635) one or more replacement values for the one or more adverse features. For example, the feature determination module 204 may determine a replacement value for each of the identified adverse input features. The replacement value for a particular adverse input feature may be determined based on input values associated with multiple previously processed transactions corresponding to the particular adverse input feature (e.g., a mean value, a minimum value, a maximum value, etc.).

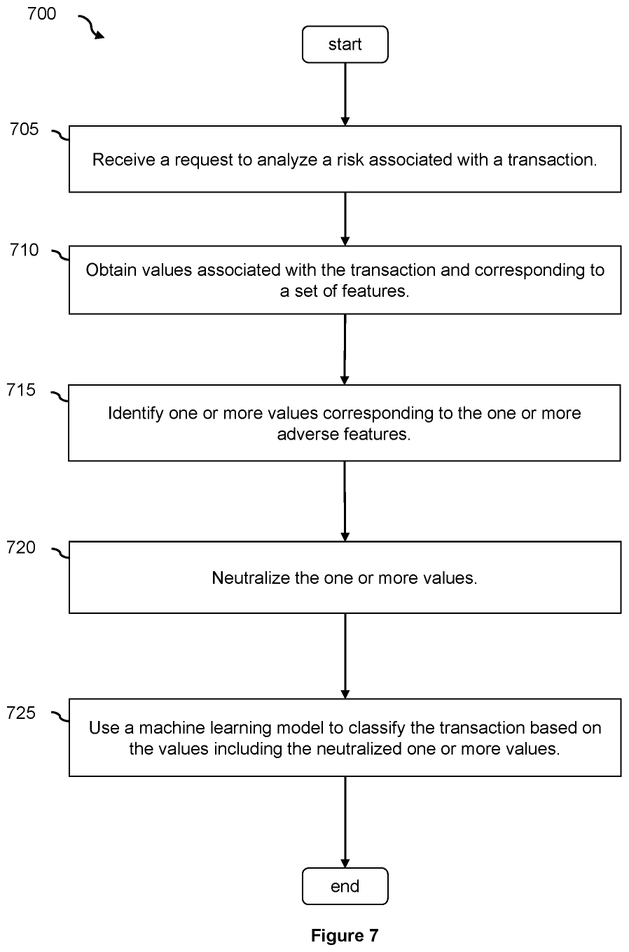

FIG. 7 illustrates a process 700 for neutralizing an effect of one or more adverse input features when using a machine learning model according to various embodiments of the disclosure. In some embodiments, at least a portion of the process 700 may be performed by the risk analysis module 132. The process 700 begins by receiving (at step 705) a request to analyze a risk associated with a transaction. For example, the risk manager 202 may receive a request for analyzing a transaction from the interface server 134 or the service application 138. The request may be initiated from the user device 110 (e.g., when the user 140 initiated a transaction request, such as a login request, a payment request, a data access request, etc.).

The process 700 then obtains (at step 710) values associated with the transaction and corresponding to a set of features. For example, the risk manager 202 may obtain input values associated with the transaction and corresponding to the set of input features 312-328. The process 700 identifies (at step 715) one or more of the input values that correspond to the one or more adverse features. For example, the risk manager 202 may identify input values that correspond to the adverse input features identified during the process 600.

The process 700 neutralizes (at step 715) the one or more values and uses (at step 720) a machine learning model to classify the transaction based on the values including the neutralized one or more values. For example, the risk manager 202 may neutralize the effect of the adverse input features by altering the one or more values associated with the transaction and corresponding to the adverse input features. In some embodiments, the risk manager 202 may neutralize the effect by altering the one or more values (e.g., replacing the one or more values with one or more replacement values). The risk manager may then use the machine learning model 212 to classify the transaction based on the unaltered values that do not correspond to the adverse input features and the altered values that correspond to the adverse input features. Based on the classification of the transaction, the risk manager 202 and/or the service application 138 may perform one or more actions associated with the transaction. For example, the service application 138 may process the transaction when the transaction is classified as a legitimate transaction and may deny the transaction when the transaction is classified as a fraudulent transaction. Furthermore, the risk manager 202 may change a setting of a user account associated with the transaction (e.g., increase the authentication requirement, etc.) when the transaction is classified as a fraudulent transaction.

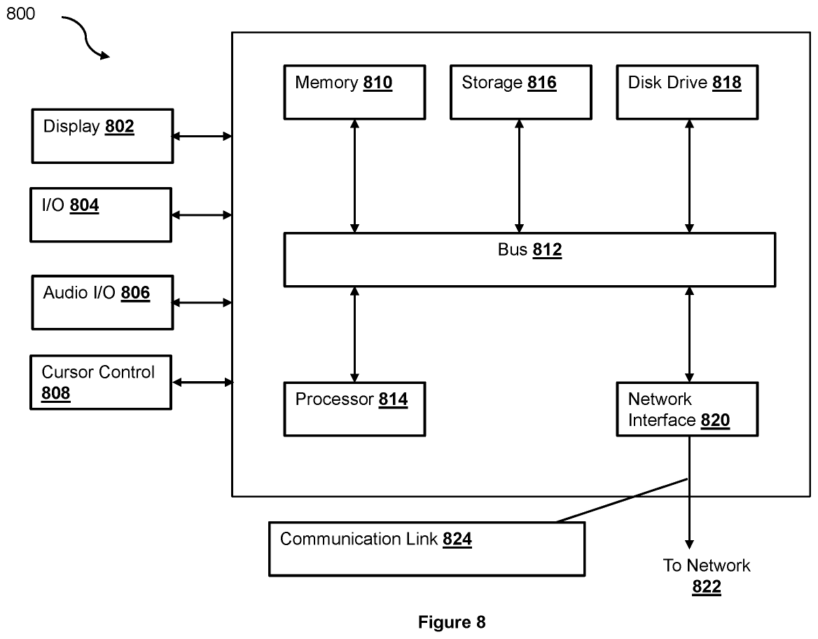

FIG. 8 is a block diagram of a computer system 800 suitable for implementing one or more embodiments of the present disclosure, including the service provider server 130, the merchant server 120, and the user device 110. In various implementations, the user device 110 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, and 130 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the adverse input features identification and neutralization functionalities described herein according to the processes 600 and 700.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
receiving a request for categorizing a first transaction;
obtaining a first plurality of values associated with the first transaction and corresponding to a plurality of data features;
based on a determination that one or more particular data features in the plurality of data features have an adverse effect on performing a correct transaction categorization by a machine learning model, neutralizing one or more values from the first plurality of values associated with the first transaction, wherein the one or more values corresponds to the one or more particular data features in the plurality of data features; and
determining, using the machine learning model, a category for the first transaction based on unaltered values from the plurality of values in addition to the neutralized one or more values.

2. The system of claim 1, wherein the operations further comprise determining, from the plurality of data features, the one or more particular data features that have an adverse effect on performing a correct transaction categorization.

3. The system of claim 2, wherein the operations further comprise:
calculating, for each data feature in the plurality of data features, a Shapley value representing a contribution of the data feature to an output value of the machine learning model, wherein the one or more particular data features are determined from the plurality of data features based on the Shapley values.

4. The system of claim 2, wherein the determining the one or more particular data features comprises:
determining a second transaction that has been incorrectly categorized by the machine learning model;
accessing a second plurality of values associated with the second transaction and corresponding to the plurality of data features; and
determining, from the second plurality of values, one or more values that contributed to an incorrect categorization of the second transaction by iteratively:
modifying each value in the second plurality of values; and
categorizing, using the machine learning model, the second transaction based on unaltered values in the second plurality of values in addition to the modified value.

5. The system of claim 2, wherein the determining the one or more particular data features comprises:
determining a second transaction that has been correctly categorized by the machine learning model;
accessing a second plurality of values associated with the second transaction and corresponding to the plurality of data features; and
determining, from the second plurality of values, one or more values that failed to contribute to a correct categorization of the second transaction by iteratively:
modifying each value in the second plurality of values; and
categorizing, using the machine learning model, the second transaction based on unaltered values in the second plurality of values in addition to the modified value.

6. The system of claim 1, wherein the neutralizing the one or more values comprises:
identifying, from the one or more values, a first value corresponding to a first data feature from the one or more particular data features;
determining, for the first data feature, a first replacement value; and
replacing the first value with the first replacement value.

7. The system of claim 6, wherein the first replacement value is determined based on first feature values associated with a plurality of previously processed transactions and corresponding to the first data feature.

8. The system of claim 7, wherein the operations further comprise determining a value distribution based on the first feature values associated with the plurality of previously processed transactions, wherein the first replacement value is determined based on the value distribution.

9. The system of claim 8, wherein the first replacement value is one of a mean, a maximum, or a minimum associated with the value distribution.

10. A method comprising:
receiving a request for classifying a first event;
obtaining a first plurality of values associated with the first event and corresponding to a plurality of input features for a machine learning model;
identifying, from the first plurality of values associated with the first event, one or more values corresponding to one or more particular input features that have an adverse effect on performing a correct event classification by the machine learning model;
altering the one or more values; and
determining, using the machine learning model, a classification for the first event based on unaltered values from the plurality of values in addition to the altered one or more values.

11. The method of claim 10, further comprising training the machine learning model based on data values corresponding to the plurality of input features and associated with a plurality of transactions.

12. The method of claim 10, further comprising:
prior to altering the one or more values in the first plurality of values, determining, using the machine learning model, a score based on unaltered values in the first plurality of values associated with the first transaction; and
determining that the score is within a predetermined threshold from a cutoff point, wherein the first transaction is classified based on the score with respect to the cutoff point, and wherein the altering the one or more values is responsive to the determining that the score is within the predetermined threshold from the cutoff point.

13. The method of claim 10, wherein the machine learning model comprises a neural network or a gradient boosting tree.

14. The method of claim 10, further comprising determining, from the plurality of input features, the one or more particular input features that have an adverse effect on performing a correct event classification.

15. The method of claim 14, wherein the determining the one or more particular input features comprises:
determining a second event that has been incorrectly classified by the machine learning model;
accessing a second plurality of values associated with the second event and corresponding to the plurality of input features; and
determining, from the second plurality of values, one or more values that contributed to an incorrect classification of the second event.

16. The method of claim 14, wherein the determining the one or more particular input features comprises:
determining a second event that has been correctly classified by the machine learning model;
accessing a second plurality of values associated with the second event and corresponding to the plurality of input features; and
determining, from the second plurality of values, one or more values that failed to contribute to a correct classification of the second event.

17. A non-transitory machine-readable medium having stored thereon machine-readable instructions executable to cause a machine to perform operations comprising:
receiving a request for determining a risk associated with a first transaction;
obtaining a first plurality of values associated with the first transaction and corresponding to a plurality of data features;
based on a determination that one or more particular data features in the plurality of data features have an adverse effect on performing a risk assessment by a machine learning model, altering one or more values from the first plurality of values associated with the first transaction, wherein the one or more values corresponds to the one or more particular data features in the plurality of data features; and
determining, using the machine learning model, a risk score for the first transaction based on unaltered values from the plurality of values in addition to the altered one or more values.

18. The non-transitory machine-readable medium of claim 17, wherein the operations further comprise:
classifying the first transaction based on the risk score; and
processing the first transaction based on the classifying, wherein the processing includes an approval or a denial of the first transaction.

19. The non-transitory machine-readable medium of claim 17, wherein the altering the one or more values comprises:
identifying, from the one or more values, a first value corresponding to a first input feature from the one or more particular input features;
determining, for the first data feature, a first replacement value; and
replacing the first value with the first replacement value.

20. The non-transitory machine-readable medium of claim 19, wherein the first replacement value is determined based on first feature values associated with a plurality of previously processed transactions and corresponding to the first data feature.
